(19) United States
(12) Patent Application Publication
(10) Pub. No.: US 2020/0023889 A1
(43) Pub. Date: Jan. 23, 2020

(54) ESTIMATING THE RACK FORCE IN A STEER-BY-WIRE SYSTEM

(71) Applicants: THYSSENKRUPP PRESTA AG, Eschen (LI); thyssenkrupp AG, Essen (DE)

(72) Inventor: Manuel ROHRMOSER, Thüringen (AT)

(73) Assignees: THYSSENKRUPP PRESTA AG, Eschen (LI); thyssenkrupp AG, Essen (DE)

(21) Appl. No.: 16/490,949

(22) PCT Filed: Mar. 13, 2018
(86) PCT No.: PCT/EP2018/056145

§ 371 Date: Sep. 4, 2019

(30) Foreign Application Priority Data
Mar. 14, 2017 (DE) 10 2017 105 370.0

(51) Int. Cl. B62D 5/04; B62D 6/00; B62D 5/00; B62D 3/12

(52) U.S. Cl. CPC B62D 5/0463; B62D 3/12; B62D 5/006; B62D 6/008

(57) ABSTRACT

A method for determining a toothed-rack force for a steer-by-wire steering system for a motor vehicle. The toothed-rack force is determined from two components, wherein, in a module for vehicle-model-based estimation of the toothed-rack force, a first component of the toothed-rack force is generated by means of a vehicle model, and, in a module for steering-gear-model-based estimation of the toothed-rack force, a second component of the toothed-rack force is generated by means of a steering gear model.

The present invention relates to a method for determining a toothed-rack force for a steer-by-wire steering system of a motor vehicle having the features of the preamble of claim 1, and to a method for controlling a steer-by-wire steering system having the features of the preamble of claim 11, and to a steer-by-wire steering system having the features of the preamble of claim 13.

In steer-by-wire steering systems, the position of the steered wheels is not directly coupled to the steering input means, for example a steering wheel. A connection exists between the steering wheel and the steered wheels by means of electrical signals. The driver steering demand is picked off by a steering angle sensor, and the position of the steered wheels is controlled by means of a steering actuator in a manner dependent on the driver steering demand. No mechanical connection to the wheels is provided, such that, after actuation of the steering wheel, no direct force feedback is transmitted to the driver. However, correspondingly adapted feedback is provided for example during parking or during straight-ahead travel, in the case of which a steering moment adapted to the vehicle reaction, which steering moment differs depending on the vehicle manufacturer, is desired as force feedback. During cornering, reaction forces act as transverse forces on the steering gear, which reaction forces are replicated by the feedback actuator in the form of a moment opposing the steering direction. The driver thus experiences a predefinable steering feel. In order, in steer-by-wire steering systems, to simulate the retroactive effects of the road on the steering wheel, it is necessary to provide, at the steering wheel or the steering column, a feedback actuator (FBA) which imparts a steering feel to the steering handle in a manner dependent on the desired retroactive effects.

The feedback characteristics of the steering system are conventionally determined by the toothed-rack force which is exerted on the toothed rack by the track rods which are attached via the running gear to the wheels. The toothed-rack force is primarily influenced by the present cornering forces. Thus, a major part of the present toothed-rack force corresponds to a transverse acceleration. The toothed-rack force is however not only determined by the transverse forces that arise whilst travelling around a corner, and it is rather the case that a multiplicity of further variables of a present driving situation have an influence on the toothed-rack force. One example for these is the road condition (unevennesses, lane grooves, friction coefficient).

In the case of electric servo steering systems (EPS), it is known for the presently acting toothed-rack force to be determined by means of a moment sensor arranged on the toothed rack or through estimation by means of a so-called observer based on a model of the steering system. Such a method is disclosed for example in the laid-open specification DE 103 320 23 A1. In said document, for the determination of a steering moment for the EPS steering system of a vehicle, the steering moment is determined in a manner dependent on the transverse force acting on steered wheels or in a manner dependent on the actual steering moment. The known method provides for the transverse force to be estimated or modelled, by means of a sensor or on the basis of a model of the steering system of the vehicle, in a manner dependent on at least one of the variables transverse acceleration, steering angle and vehicle speed. This model has proven to be disadvantageous because it does not take into consideration further disturbance influences, such as for example roadway conditions, and therefore does not have the desired accuracy. Furthermore, a toothed-rack force cannot be estimated if the gear is not being moved and the toothed-rack force lies within the static friction.

It is therefore an object of the present invention to specify a method for determining a toothed-rack force for a steer-by-wire steering system of a motor vehicle, and a method for controlling a steer-by-wire steering system for motor vehicles, which permit a more accurate determination of the toothed-rack force and thus permit improved steering feel and are at the same time designed to cause the least possible interference. Furthermore, it is sought to specify a steer-by-wire steering system which permits improved steering characteristics.

Said object is achieved by a method for determining a toothed-rack force for a steer-by-wire steering system of a motor vehicle having the features of claim 1, by a method for controlling a steer-by-wire steering system for motor vehicles having the features of claim 12, and by a steer-by-wire steering system for motor vehicles having the features of claim 14. The subclaims specify advantageous refinements of the invention.

Accordingly, a method for determining a toothed-rack force for a steer-by-wire steering system for a motor vehicle is provided, wherein the toothed-rack force is determined from two components, wherein, in a module for vehicle-model-based estimation of the toothed-rack force, a first component of the toothed-rack force is generated by means of a vehicle model, and, in a module for steering-gear-model-based estimation of the toothed-rack force, a second component of the toothed-rack force is generated by means of a steering gear model. In this way, the quality of the feedback from the road to the driver, and thus the steering feel of a steer-by-wire system designed according to the invention, are considerably improved, because the disadvantages of the individual methods can be compensated by means of the respective other method. Through the combination of both estimation models, it is possible overall to ensure a more accurate estimation of the present toothed-rack force, and for the vehicle driver to thus be provided with improved and more stable feedback at the steering input means. Furthermore, the toothed-rack force can be estimated even when the gear is at a standstill or during small movements of the gear within the static friction.

The two components of the toothed-rack force are preferably combined and weighted to form a toothed-rack force, wherein the weighting of the two components is performed in a manner dependent on driving conditions. It is preferable if the weighting is performed by means of covariance matrices, such that the best possible estimation can be achieved for the respective driving condition.

In a preferred embodiment, the module for vehicle-model-based estimation of the toothed-rack force comprises a non-linear vehicle model. It is advantageous here if the non-measurable states, in particular the lateral speed and the lateral tire slip angle, are estimated by means of a Kalman filter. It is furthermore advantageous if the non-linear vehicle model comprises a linear single-track model with a tire load model and with a non-linear tire model, on the basis of which the lateral tire force is determined taking into consideration the self-aligning moments.

The module for steering-gear-model-based estimation of the toothed-rack force may, in a first embodiment, comprise a non-linear steering gear model with a separate friction modelling means, wherein the friction-dependent steering-gear-model-based toothed-rack force is determined by means of an estimator. By means of the friction model, it is possible for the real characteristics of the steering gear to be incorporated into the estimation.

In a further embodiment, provision is made whereby an estimator operates with non-linear estimation methods, and/or a friction model of a friction modelling means is a static or asymmetrical, modified dynamic friction model. The estimator preferably operates with non-linear estimation methods, wherein here, use is made of an extended Kalman filter (EKF) or an unscented Kalman filter (UKF), and the friction model is a Lund-Grenoble friction model.

The estimator is preferably based on a linear Kalman filter with friction compensation, wherein the non-linear part of the model is implemented as a compensation element. In a third embodiment, the module for steering-gear-model-based estimation of the toothed-rack force comprises model-based parameter estimation, wherein the friction characteristics of the steering gear are determined online, which permits an adaptive estimation of the friction-dependent steering-gear-model-based toothed-rack force. Here, the model is continuously updated, which makes the estimation of the steering-gear-model-based toothed-rack force independent of mechanical changes to the steering gear.

Also provided is a method for controlling a steer-by-wire steering system for a motor vehicle, comprising:
an electronically controllable steering actuator which acts on the steered wheels,
a control unit,
a feedback actuator to which a driver demand for a steering angle can be applied by a driver by way of a steering input means and which outputs a feedback signal to the steering input means in reaction to the driver demand and to a driving state of the motor vehicle,
a signal transmission means which transmits the driver demand to the control unit,
wherein the control unit controls the steering actuator in order to transform the driver demand into a deflection of the steered wheels, wherein
   the feedback signal is implemented in a manner dependent on an estimated toothed-rack force, and wherein the toothed-rack force is estimated by means of a method as described above.

It is preferable here if, from the difference between the steering-gear-model-based toothed-rack force and the vehicle-model-based toothed-rack force, the present road friction is determined, and this is used as an input for the module for vehicle-model-based estimation of the toothed-rack force. In this way, a high level of estimation accuracy of the vehicle-model-based estimation can be ensured independently of the present road conditions.

Also provided is a corresponding steer-by-wire steering system for a motor vehicle, which is configured to carry out a method as described above.

Preferred embodiments of the invention will be discussed in more detail below on the basis of the drawings. Identical components or components of identical action will be denoted by the same reference designations in the figures, in which:

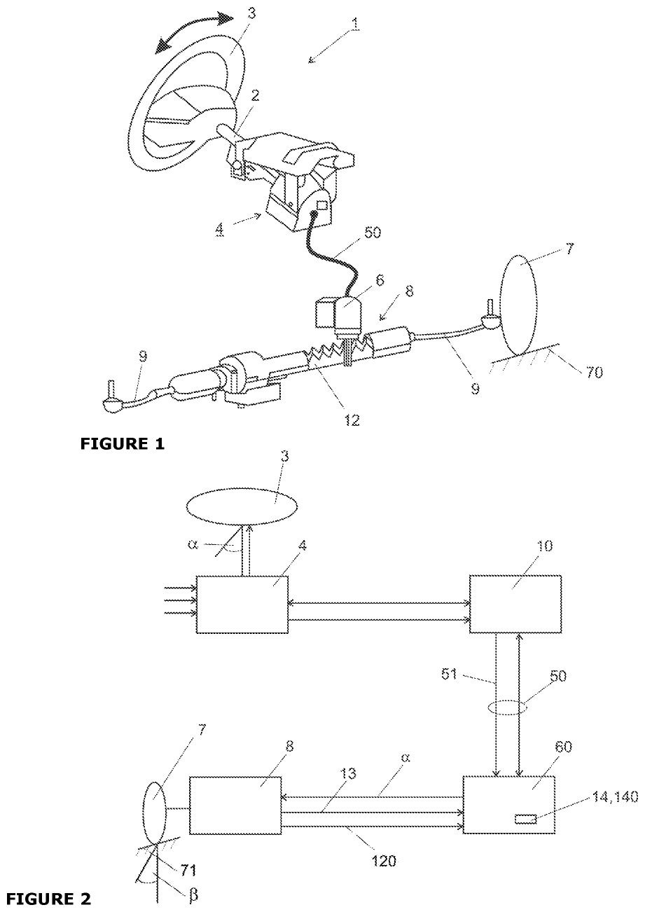

FIG. 1 is a schematic illustration of a steer-by-wire steering system,

FIG. 2 shows a block diagram of a controller of the steer-by-wire steering system with a module for determining the toothed-rack force,

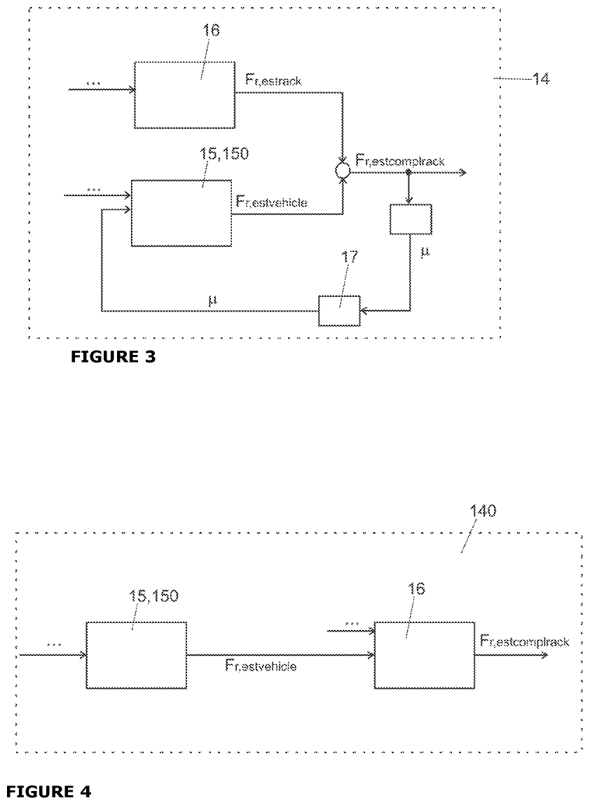

FIG. 3 shows a block diagram of the module for determining the toothed-rack force with a module for steering-gear-model-based estimation of the toothed-rack force and with a module for vehicle-model-based estimation of the toothed-rack force,

FIG. 4 shows a further block diagram of the module for determining the toothed-rack force with a module for vehicle-model-based estimation of the toothed-rack force and with a module for steering-gear-model-based estimation of the toothed-rack force,

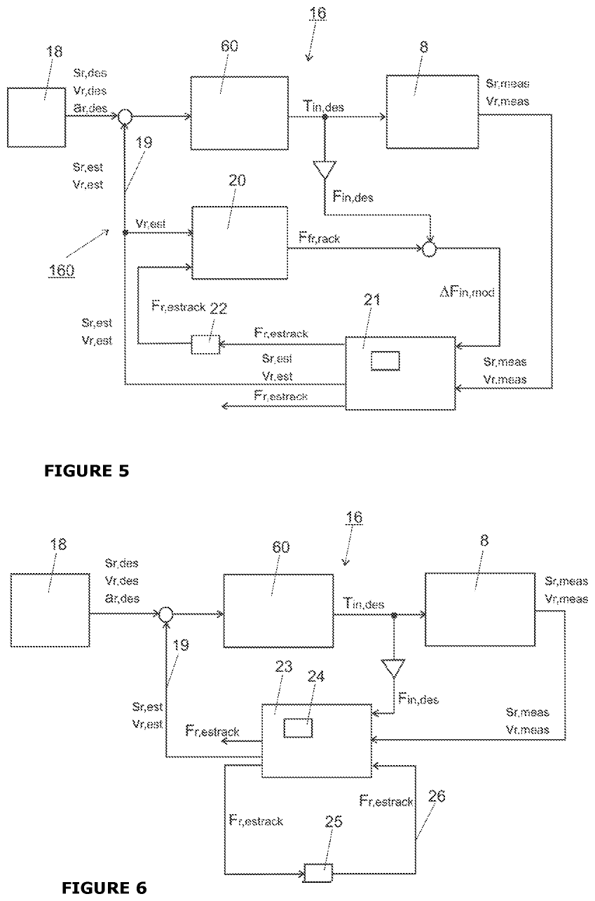

FIG. 5 shows a block diagram of a first module for steering-gear-model-based estimation of the toothed-rack force,

FIG. 6 shows a block diagram of a second module for steering-gear-model-based estimation of the toothed-rack force,

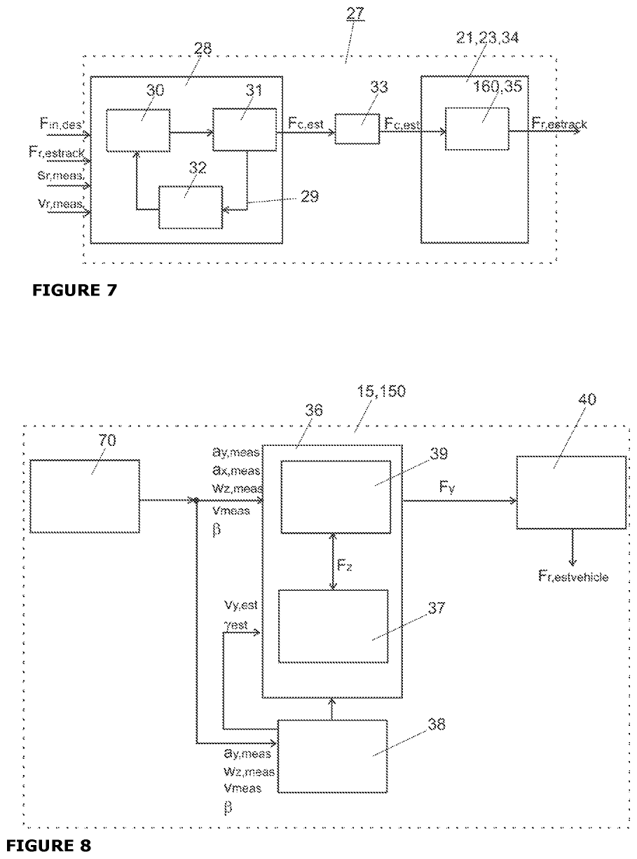

FIG. 7 shows a block diagram of a third module for steering-gear-model-based estimation of the toothed-rack force with a model-based parameter estimator, and

FIG. 8 shows a block diagram of a module for vehicle-model-based estimation of the toothed-rack force.

FIG. 1 shows a steer-by-wire steering system 1. Attached to a steering shaft 2 is a rotational angle sensor (not illustrated) which detects the driver steering angle imparted by rotation of a steering input means 3, which in the example is in the form of a steering wheel. It is however additionally also possible for a steering moments to be detected. A joystick may serve as steering input means. Also attached to the steering shaft 2 is a feedback actuator 4 which serves for simulating the retroactive effects of the roadway 71 on the steering wheel 3 and thus providing the driver with feedback regarding the steering and driving characteristics of the vehicle. The driver steering demand is, by means of the rotational angle α, measured by the rotational angle sensor, of the steering shaft 2, transmitted via signal lines to a feedback actuator monitor unit 10, as illustrated in FIG. 2. The feedback actuator monitor unit 10 transmits the driver steering demand to the control unit 60. The feedback actuator monitor unit 10 preferably also performs the control of the feedback actuator 4. The feedback actuator monitor unit 10 may also be formed integrally with the control unit 60. The control unit 60 controls, in a manner dependent on the signal of the rotational angle sensor and further input variables, an electrical steering actuator 6 which controls the position of the steered wheels 7. The steering actuator 6 acts indirectly on the steered wheels 7 via a steering-rack-type steering gear 8, such as for example a toothed-rack-type steering gear, and via track rods 9 and other components.

FIG. 2 shows a controller of the feedback actuator 4. The feedback actuator 4 receives signals via the signal line 50 inter alia from the rotational angle sensor, which measures and stores the steering angle α, the steering angle acceleration and the steering angle speed. The feedback actuator 4 communicates with a feedback actuator monitor unit 10, which controls the feedback actuator 4. The feedback actuator monitor unit 10 receives, from a control unit 60 of the steering actuator 6, the actual wheel steering angle β of the steered wheels 7 and further variables that the control unit 60 has determined. The toothed-rack position 120 measured at a toothed rack 12, and further roadway information items 13, are transmitted to the control unit 60. The control unit 60 comprises a module for determining the toothed-rack force 14. The estimated toothed-rack force is transmitted to the feedback actuator monitor unit 10, which, on the basis of the toothed-rack force, controls the feedback actuator 4 and thus generates a steering feel. The control unit 60 furthermore receives steering commands 51 from a driver, such as the steering angle status.

FIG. 3 illustrates the module for determining the toothed-rack force 14, comprising a module 15 for vehicle-model-based estimation of the toothed-rack force and a module for steering-gear-model-based estimation 16 of the toothed-rack force. The module for vehicle-model-based estimation of the toothed-rack force 15 comprises a vehicle model 150, in which roadway information items are implemented. The module for steering-gear-model-based estimation of the toothed-rack force 16 estimates the toothed-rack force on the basis of toothed-rack information items (for example the toothed-rack position). The module 16 is independent of roadway information items. To determine the toothed-rack force F_{r,estcomplrack}, a difference is formed between the steering-gear-model-based toothed-rack force F_{r,estrack} and the vehicle-model-based toothed-rack force F_{r,estvehicle}. The difference between the two values yields the present road friction μ, which, after passing through a delay unit 17, is used as an input for the module for vehicle-model-based estimation of the toothed-rack force 15. The steering-gear-model-based estimation thus supports the vehicle-model-based estimation of the toothed-rack force.

FIG. 4 illustrates an alternative module 140 for determining the toothed-rack force F_{r,estcomplrack}. Here, the vehicle-model-based estimation of the toothed-rack force F_{r,estvehicle} is supplemented by the steering-gear-model-based toothed-rack force F_{r,estrack} and is weighted and combined in a manner dependent on the driving state by means of weighting matrices. In this way, for example during cornering, when the vehicle is steered with a constant steering angle β, such that no movement occurs at the toothed rack and the toothed-rack forces lie within the range of static friction of the steering gear, the toothed-rack force F_{r,estcomplrack} can nevertheless be estimated. The vehicle-model-based estimation thus supports the steering-gear-model-based estimation.

Furthermore, it is also conceivable and possible for the two modules 14, 140 to be combined with one another and to be used for the respective situation in a manner dependent on the driving conditions and requirements. FIG. 5 shows an embodiment of a module for steering-gear-model-based estimation of the toothed-rack force 16 with a non-linear steering gear model 160. The control unit 60 receives setpoint toothed-rack values as an input from a unit 18. Said setpoint toothed-rack values include the setpoint toothed-rack position S_{r,des}, the setpoint toothed-rack speed v_{r,des} and the setpoint toothed-rack acceleration a_{r,des}. From the input S_{r,des}, v_{r,des}, a_{r,des}, the control unit 60 determines a setpoint torque T_{in,des} for the control of the steering gear 8. The setpoint torque T_{in,des} is converted into a setpoint toothed-rack force F_{in,des}. The actual toothed-rack position S_{r,meas} and the actual toothed-rack speed v_{r,meas} are measured and used as an input for an estimator 21. A separate friction modelling means 20 determines a friction force F_{fr,rack} on the basis of a speed of the toothed rack v_{r,est} estimated by means of the estimator 21 and on the basis of a friction-dependent steering-gear-model-based toothed-rack force F_{r,estrack}, which is likewise determined by the estimator 21. Said friction force F_{fr,rack} is offset against the setpoint toothed-rack force F_{in,des}, and the difference between the two toothed-rack force components ΔF_{in,mod} forms the result, which is used as an input for the estimator 21, which additionally receives the measured toothed-rack position s_{r,meas} and the measured toothed-rack speed v_{r,meas} as inputs. The estimator 21 determines the friction-dependent steering-gear-model-based toothed-rack force F_{r,estrack} and transmits this, after it has passed through a delay unit 22, to the friction model 20 as an input, because the friction of the gear is dependent on the toothed-rack force. The estimator 21 furthermore determines the estimated toothed-rack position s_{r,est} and the estimated toothed-rack speed v_{r,est,} wherein the two values are fed, in a feedback loop 19, to the control unit 60. The estimator 21 preferably operates with linear estimation methods (Kalman, Luenberger) with friction compensation, wherein the non-linear part, that is to say the friction model, of the model is implemented as a compensation element. The friction model is preferably an asymmetrical, modified dynamic friction model, in particular a Lund-Grenoble friction model. It may however also be an asymmetrical, modified steady-state friction model, wherein the friction model includes Coulomb friction, viscous friction and/or Stribeck friction.

FIG. 6 shows a second embodiment of a module for steering-gear-model-based estimation of the toothed-rack force 16 with model-based estimation of the toothed-rack force. As in the preceding exemplary embodiment, the control unit 60 receives setpoint toothed-rack values as an input from a unit 18. These include the setpoint toothed-rack position S_{r,des,} the setpoint toothed-rack speed v_{r,des} and the setpoint toothed-rack acceleration a_{r,des}. From the input s_{r,des} and v_{r,des}, the control unit 60 determines a setpoint torque T_{in,des} for the control of the steering gear 8. The actual toothed-rack position S_{r,meas} and the actual toothed-rack speed v_{r,meas} are measured and used as an input for an estimator 23. From the setpoint torque T_{in,des}, a setpoint toothed-rack force F_{in,des} is determined, and this is fed to the estimator 23 with the measured toothed-rack values, the toothed-rack position s_{r,meas} and the toothed-rack speed v_{r,meas}. The estimator 23 contains the entire steering gear model including friction model 24. Here, the estimator 23 may use non-linear estimation methods with, for example, extended Kalman filters (EKF), unscented Kalman filters (UKF) or the like. The estimator 23 determines the friction-dependent steering-gear-model-based toothed-rack force Fr,estrack, which, after it has passed through a delay unit 25, is fed back in a feedback loop 26 as an input to the estimator 23. The friction model 24 is preferably an asymmetrical, modified dynamic friction model, in particular a Lund-Grenoble friction model. It may however also be an asymmetrical, modified steady-state friction model, wherein the friction model includes Coulomb friction, viscous friction and/or Stribeck friction. The estimator 23 furthermore determines an estimated toothed-rack position S_{r,est} and an estimated toothed-rack speed v_{r,est}, which are fed back in a feedback loop 19 to the control unit 60.

FIG. 7 shows a model-based parameter estimation means 27 which permits adaptive estimation of the friction-dependent steering-gear-model-based toothed-rack force F_{r,estrack}. The friction characteristics of the steering gear are determined online, that is to say the model is updated and the estimation of the toothed-rack force is thus independent of mechanical changes to the steering gear. By means of this adaptive estimation, a very high level of accuracy is achieved over the entire service life of the steering gear. The measured actual toothed-rack position s_{r,meas} determined from the measured toothed-rack values, the actual toothed-rack speed v_{r,meas} and the setpoint toothed-rack force F_{in,des} and the estimated toothed-rack force F_{r,estrack} are transmitted as an input to an estimator 28 provided for friction determination. Said estimator 28 estimates friction parameters F_{c,est}, such as for example asymmetrical static friction, and updates the friction values online by means of a feedback loop 29. In a first step, the friction characteristics are determined online, 30, and subsequently, a moving average is formed 31, which is in turn buffered 32 as a new parameter and transmitted as an input to the friction determination. An evaluation unit 33 establishes whether a change in the friction parameters F_{c,est} is present and transmits the updated value as an input to a steering-gear-model-based estimator 21, 23, 34. The steering-gear-model-based estimator 21, 23, 34 estimates, by means of a steering gear model 160, 35 and on the basis of the updated value F_{c,est}, a friction-dependent steering-gear-model-based toothed-rack force F_{r,estrack}. The adaptive estimation uses non-linear estimation methods, for example with an EKF, and is implemented in the case of very low friction coefficients <=0 for the steering-gear-model-based estimation of the toothed-rack force.

FIG. 8 schematically illustrates a preferred embodiment of a module for vehicle-model-based estimation 15. The module comprises a non-linear vehicle model 150 with a single-track model 36 with a non-linear tire model 37. Single-track models determine the lateral forces acting on the tires or on the associated axle in a manner dependent on a slip angle of the wheels, and are known from the prior art. The measured vehicle states 70, a lateral acceleration a_{x,meas} and a longitudinal acceleration a_{y,meas}, the rotation about the vertical axis or yaw axis w_{z,meas}, the vehicle speed vₘₑₐₛ and the steering angle β at the wheels 7, serve as inputs for the single-track model 36. The lateral acceleration a_{y,meas}, the rotation about the yaw axis w_{z,meas}, the vehicle speed vₘₑₐₛ and the wheel steering angle β serve as inputs for an estimator 38, which estimates the non-measurable states, that is to say the lateral speed v_{y,meas} and the lateral tire slip angle γₑₛₜ with the aid of a Kalman filter (EKF/UKF). The estimated values are input into the single-track model 36. The single-track model 36 comprises a tire load model 39 and the tire model 37, on the basis of which the lateral tire force F_{y} is determined taking into consideration the self-aligning moments. With the aid of the steering geometry of the steering gear 40, from this in turn, the vehicle-model-based toothed-rack force F_{r,estvehicle} is derived.

By means of the combinations of the two methods, vehicle-model-based estimation and steering-gear-model-based estimation, illustrated in FIG. 3 and FIG. 4, the weaknesses of the individual methods can be compensated.

Here, the weighting of the two methods is performed in a manner dependent on the driving conditions. A Kalman-based fusion of the two methods (EKF, UKF) is preferably implemented. The individual estimation results are weighted in accordance with the driving conditions by means of covariance matrices. In the presence of defined driving conditions, the steering-gear-model-based estimation supports the vehicle-model-based estimation. The toothed-rack forces, for example within the range of static friction of the steering gear, can thus be better estimated. Since the vehicle model is valid only in the case of dry asphalt, the vehicle-model-based estimation of the toothed-rack force is also valid only in the case of dry asphalt. By calculating the difference between the steering-gear-model-based toothed-rack force and the vehicle-model-based toothed-rack force, the friction coefficient p of the road can be determined. If this coefficient is fed back into the vehicle-model-based estimation, then the estimation of this method is likewise accurate and independent of the present road conditions.

1.-13. (canceled)

14. A method for determining a toothed-rack force for a steer-by-wire steering system for a motor vehicle, comprising:
determining the toothed-rack force from two components,
generating, in a module for vehicle-model-based estimation of the toothed-rack force, a first component of the toothed-rack force by means of a vehicle model, and
generating, in a module for steering-gear-model-based estimation of the toothed-rack force, a second component of the toothed-rack force by means of a steering gear model.

15. The method of claim 14, wherein the two components of the toothed-rack force are combined and weighted to form the toothed-rack force, wherein the weighting of the two components is performed in a manner dependent on driving conditions.

16. The method of claim 15, wherein the weighting is performed by covariance matrices.

17. The method of claim 14, wherein the module for vehicle-model-based estimation of the toothed-rack force comprises a non-linear vehicle model.

18. The method of claim 17, wherein the module for vehicle-model-based estimation of the toothed-rack force comprises an estimator that estimates non-measurable states by means of a Kalman filter.

19. The method of claim 17, wherein the non-linear vehicle model comprises a linear single-track model with a tire load model and with a non-linear tire model, on the basis of which the lateral tire force is determined taking into consideration self-aligning moments.

20. The method of claim 14, wherein the module for steering-gear-model-based estimation of the toothed-rack force comprises a non-linear steering gear model with a separate friction modelling means, wherein the friction-dependent steering-gear-model-based toothed-rack force is ascertained by means of an estimator.

21. The method of claim 20, wherein the estimator operates with non-linear estimation methods, and/or the friction model of the friction modelling means is an asymmetrical, modified dynamic friction model.

22. The method of claim 21, wherein the friction model is a Lund-Grenoble friction model.

23. The method of claim 20, wherein the estimator is based on a linear Kalman filter with friction compensation, wherein the non-linear part of the model is implemented as a compensation element.

24. The method of claim 14, wherein the module for steering-gear-model-based estimation of the toothed-rack force comprises model-based parameter estimation, wherein the friction characteristics of the steering gear are determined online, which permits an adaptive estimation of the friction-dependent steering-gear-model-based toothed-rack force.

25. A method for controlling a steer-by-wire steering system for a motor vehicle, including an electronically controllable steering actuator which acts on the steered wheels, a control unit, a feedback actuator to which a driver demand for a steering angle can be applied by a driver by way of a steering input means and which outputs a feedback signal to the steering input means in reaction to the driver demand and to a driving state of the motor vehicle, a signal transmitter which transmits the driver demand to the control unit, wherein the control unit controls the steering actuator to transform the driver demand into a deflection of the steered wheels, and wherein the feedback signal is implemented in a manner dependent on an estimated toothed-rack force, wherein the toothed-rack force is estimated by a method, comprising:
determining the toothed-rack force from two components,
generating, in a module for vehicle-model-based estimation of the toothed-rack force, a first component of the toothed-rack force by means of a vehicle model, and
generating, in a module for steering-gear-model-based estimation of the toothed-rack force, a second component of the toothed-rack force by means of a steering gear model.

26. The method of claim 25, wherein, from the difference between the steering-gear-model-based toothed-rack force and the vehicle-model-based toothed-rack force, the road friction is determined, which is used as an input for the module for vehicle-model-based estimation of the toothed-rack force.

27. A steer-by-wire steering system for a motor vehicle, comprising:
an electronically controllable steering actuator which acts on the steered wheels,
a control unit,
a feedback actuator to which a driver demand for a steering angle can be applied by a driver by way of a steering input means and which outputs a feedback signal to the steering input means in reaction to the driver demand and to a driving state of the motor vehicle,
a signal transmitter which transmits the driver demand to the control unit,
wherein the control unit controls the steering actuator in order to transform the driver demand into a deflection of the steered wheels,
wherein the steer-by-wire steering system is configured to carry out a method comprising:
determining the toothed-rack force from two components,
generating, in a module for vehicle-model-based estimation of the toothed-rack force, a first component of the toothed-rack force by means of a vehicle model, and
generating, in a module for steering-gear-model-based estimation of the toothed-rack force, a second component of the toothed-rack force by means of a steering gear model.
